(19) United States
(12) Patent Application Publication
(10) Pub. No.: US 2018/0132229 A1
(43) Pub. Date: May 10, 2018

(54) Method And Apparatus For Multiplexing Physical Uplink Control Channels In Mobile Communications

(71) Applicant: MediaTek Inc., Hsinchu City (TW)

(72) Inventor: Xiu-Sheng Li, Hsinchu City (TW)

(21) Appl. No.: 15/800,325

(22) Filed: Nov. 1, 2017

Related U.S. Application Data
(60) Provisional application No. 62/417,386, filed on Nov. 4, 2016.

(51) Int. Cl. H04W 72/04; H04W 52/02; H04L 1/00; H04W 72/12; H04L 5/00

(52) U.S. Cl. CPC H04W 72/0413; H04W 52/0209; H04L 5/001; H04W 72/1268; H04L 1/0013

(57) ABSTRACT

Various solutions for multiplexing physical uplink control channels with respect to user equipment (UE) and network apparatus in mobile communications are described. A UE may receive control information from a network apparatus. The UE may multiplex a short physical uplink control channel (PUCCH) and a physical uplink shared channel (PUSCH) in a transmission time interval (TTI) according to the control information. The UE may transmit the multiplexed short PUCCH and PUSCH to a network apparatus. The short PUCCH and the PUSCH may be multiplexed by time division multiplexing (TDM) or frequency division multiplexing (FDM). The control information may be configured by radio resource control (RRC) layer signaling or indicated by physical layer signaling or L1 signaling.

### CROSS REFERENCE TO RELATED PATENT APPLICATION

The present disclosure claims the priority benefit of U.S. Provisional Patent Application No. 62/417,386, filed on 4 Nov. 2016, the content of which is incorporated by reference in its entirety.

### TECHNICAL FIELD

The present disclosure is generally related to mobile communications and, more particularly, to multiplexing physical uplink control channels with respect to user equipment in mobile communications.

### BACKGROUND

Unless otherwise indicated herein, approaches described in this section are not prior art to the claims listed below and are not admitted as prior art by inclusion in this section.

There are various well-developed and well-defined cellular communications technologies in telecommunications that enable wireless communications using mobile terminals, or user equipment (UE). For example, the Global System for Mobile communications (GSM) is a well-defined and commonly used communications system, which uses time division multiple access (TDMA) technology, which is a multiplex access scheme for digital radio, to send voice, video, data, and signaling information (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Long-Term Evolution (LTE), as well as its derivatives such as LTE-Advanced and LTE-Advanced Pro, is a standard for high-speed wireless communication for mobile phones and data terminals.

In a LTE communication system, the UE may transmit uplink signals via a physical uplink control channel (PUCCH) and a physical uplink shared channel (PUSCH). It is necessary for the UE to transmit uplink control information (UCI) to the network apparatus. The UCI may comprise acknowledgements (ACK), negative acknowledgements (NACK) or scheduling requests (SR). The UCI is transported by using the PUCCH. The network apparatus may configure dedicated and periodic resources for the UE to transmit the PUCCH. However, in a newly developed communication system (e.g., a 5th Generation (5G) communication system or a New Radio (NR) communication system), a new type of PUCCH (e.g., short PUCCH) is introduced. The short PUCCH may occupy only few orthogonal frequency-division multiplexing (OFDM) symbols and may be dynamically transmitted. The resource allocation for the may also be dynamically configured. Therefore, how to properly transmit the short PUCCH may become an important issue in the newly developed communication system.

Accordingly, it is important to properly transmit the short PUCCH by considering UE power consumption and radio resource efficiency. Therefore, in developing future communication system, it is needed to provide proper short PUCCH transmission mechanisms for the UE to transmit the UCI in an efficient way and in a flexible way.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to multiplexing physical uplink control channels with respect to user equipment and network apparatus in mobile communications.

In one aspect, a method may involve an apparatus multiplexing a short physical uplink control channel (PUCCH) and a physical uplink shared channel (PUSCH) in a transmission time interval (TTI). The method may also involve the apparatus transmitting the multiplexed short PUCCH and PUSCH to a network apparatus. The short PUCCH and the PUSCH are multiplexed by time division multiplexing (TDM) or frequency division multiplexing (FDM).

In another aspect, a method may involve an apparatus receiving a control information from a network apparatus. The method may also involve the apparatus determining time duration of at least one of a physical uplink shared channel (PUSCH) and a physical downlink shared channel (PDSCH) in a transmission time interval (TTI) according to the control information. The method may further involve the apparatus scheduling the TTI according to the determined time duration. The control information may indicate the time duration of at least one of the PUSCH and the PDSCH. The control information is configured by radio resource control (RRC) layer signaling or indicated by physical layer signaling or L1 signaling.

In yet another aspect, a method may involve an apparatus multiplexing a short physical uplink control channel (PUCCH) and a sounding reference signal (SRS) in a transmission time interval (TTI). The method may also involve the apparatus transmitting the multiplexed short PUCCH and SRS to a network apparatus. The short PUCCH and the SRS are multiplexed by time division multiplexing (TDM), frequency division multiplexing (FDM) or code division multiplexing (CDM).

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIGS. 1A-1D are diagrams depicting example scenarios under schemes in accordance with implementations of the present disclosure.

FIGS. 2A and 2B are diagrams depicting example scenarios under schemes in accordance with implementations of the present disclosure.

FIG. 3 is a table depicting an example combination of joint encoding under schemes in accordance with implementations of the present disclosure.

FIGS. 4A-4D are diagrams depicting example scenarios under schemes in accordance with implementations of the present disclosure.

FIGS. 5A-5D are diagrams depicting example scenarios under schemes in accordance with implementations of the present disclosure.

FIG. 6 is a block diagram of an example communication apparatus and an example network apparatus in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to multiplexing physical uplink control channels with respect to user equipment in mobile communications. According to the present disclosure, a number of possible solutions may be implemented separately or jointly. That is, although these possible solutions may be described below separately, two or more of these possible solutions may be implemented in one combination or another.

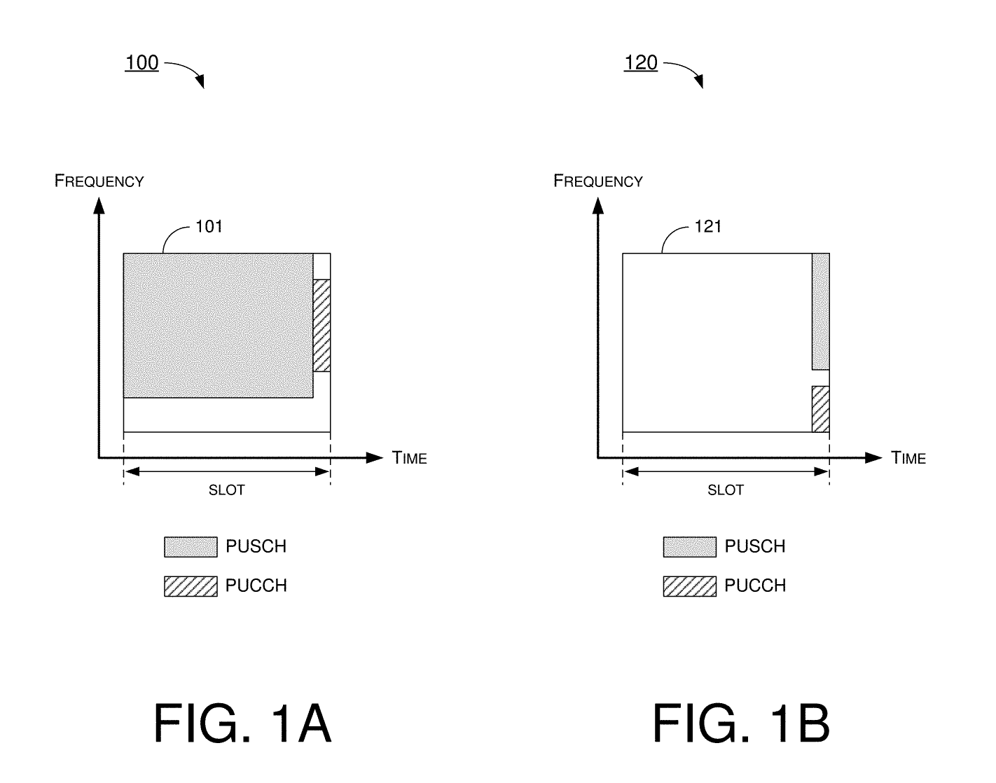

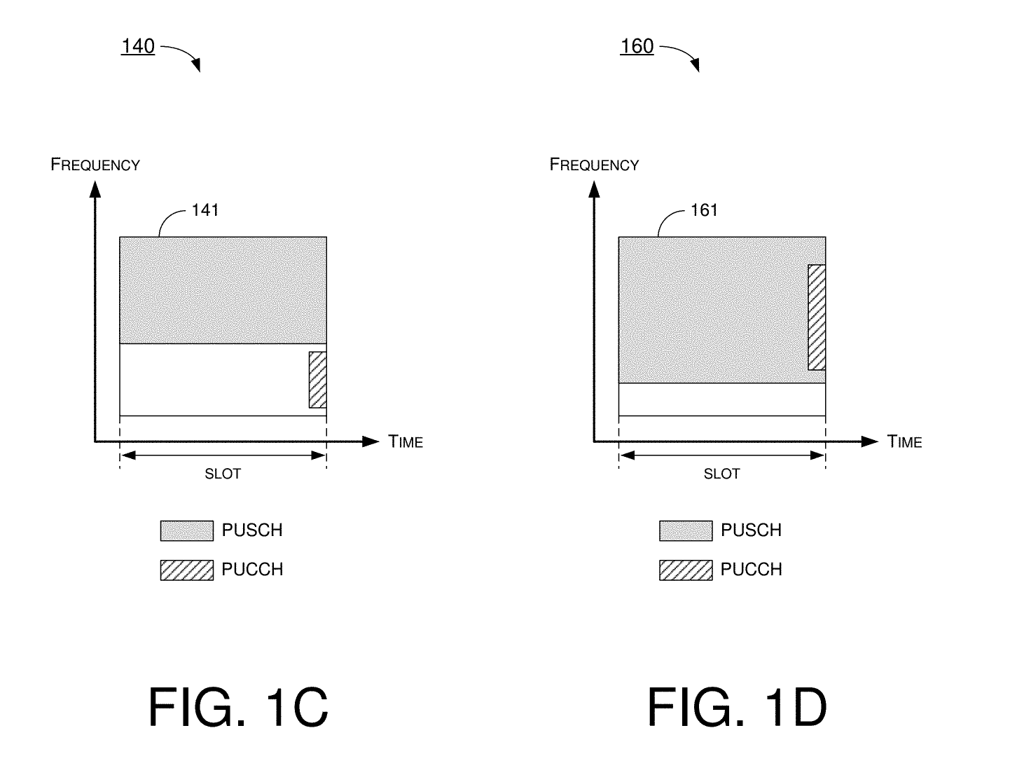

FIGS. 1A-1D illustrate example scenarios 100, 120, 140 and 160 under schemes in accordance with implementations of the present disclosure. Scenarios 100, 120, 140 and 160 involve a user equipment (UE) and a network apparatus (e.g., a base station), which may be a part of a wireless network (e.g., a LTE network, a LTE-Advanced network, a LTE-Advanced Pro network, a 5th Generation (5G) network, a New Radio (NR) network or an Internet of Things (IoT) network). The UE may be configured to transmit uplink signals to the network apparatus. The uplink signals may comprise, for example and without limitation, a physical uplink control channel (PUCCH), a physical uplink shared channel (PUSCH) or a sounding reference signal (SRS). In NR communication system, a short PUCCH is newly introduced. In general, the goal of a short PUCCH is to transmit uplink control information (UCI), which may include at least one of acknowledgements (ACK), negative acknowledgements (NACK) and scheduling requests (SR). The ACK, NACK and SR may be transmitted simultaneously or, alternatively, transmitted separately. The short PUCCH may occupy, for example and without limitation, one, two or only few orthogonal frequency-division multiplexing (OFDM) symbols. In order to transmit the short PUCCH in more efficient and flexible way, multiplexing the short PUCCH with other channels is disclosed in the present disclosure. Multiplexing the short PUCCH with the PUSCH and multiplexing the short PUCCH with the SRS will be described in the following descriptions.

FIG. 1A illustrates an example scenario 100 of multiplexing the short PUCCH and the PUSCH. As showed in FIG. 1A, the UE may be configured to multiplex the short PUCCH and the PUSCH in a transmission time interval (TTI) by time division multiplexing (TDM). A TTI is a scheduling unit of a communication network which may be, for example and without limitation, a transmission sub-frame in a LTE network or a transmission slot in a NR network. For example, slot 101 may comprise 14 OFDM symbols in time domain. The short PUCCH may occupy only one OFDM symbol. The UE may be configured to schedule the PUSCH in the first 13 OFDM symbols of slot 101 and schedule the short PUCCH in the last OFDM symbol of slot 101. Accordingly, the short PUCCH and the PUSCH are multiplexed in different time duration within slot 101. Further, the PUSCH may be scheduled in a first set of sub-carriers and the short PUCCH may be scheduled in a second set of sub-carriers in frequency domain. The first set of sub-carriers and the second set of sub-carriers may be different or identical. The UE may be further configured to transmit the multiplexed short PUCCH and PUSCH to the network apparatus.

FIG. 1B illustrates an example scenario 120 of multiplexing the short PUCCH and the PUSCH. As showed in FIG. 1B, the UE may be configured to multiplex the short PUCCH and the PUSCH in slot 121 by frequency division multiplexing (FDM). Specifically, slot 121 may comprise 14 OFDM symbols in time domain. The PUSCH in this example is one-symbol PUSCH and is scheduled in the last OFDM symbol of slot 121. The short PUCCH is also scheduled in the last OFDM symbol of slot 121. However, the short PUCCH and the PUSCH are multiplexed in non-overlapping physical resource blocks (PRBs) or resource elements (REs). The PUSCH may be scheduled in a first set of sub-carriers and the short PUCCH may be scheduled in a second set of sub-carriers in frequency domain. The first set of sub-carriers and the second set of sub-carriers may be different and non-overlapping. Accordingly, the short PUCCH and the PUSCH are multiplexed in the same time duration and in non-overlapping PRBs. The UE may be further configured to transmit the multiplexed short PUCCH and PUSCH to the network apparatus.

In another aspect, when the short PUCCH and the PUSCH are multiplexed in the same time duration, UE transmission power control should be further considered. Specifically, the UE may be configured with a maximum transmission power and is not allowed to transmit signals over the maximum transmission power. When the UE is configured to transmit the short PUCCH and the PUSCH at the same time, the transmission power may need to be distributed between the short PUCCH and the PUSCH. For example, the UE may be configured to determine a first transmission power for the short PUCCH and determine a second transmission power for the PUSCH when the short PUCCH and the PUSCH are multiplexed in the same time duration. Since the short PUCCH may be more important than the PUSCH, the UE may transmit the short PUCCH with major power and transmit the PUSCH with remaining power (e.g., the first transmission power is greater than the second transmission power). In another example, the UE may be configured to determine a first weighting factor for the short PUCCH and determine a second weighting factor for the PUSCH. The first weighting factor may be greater than the second weighting factor. The UE may be configured to distribute the transmission power according to the first weighting factor and the second weighting factor.

FIG. 10 illustrates an example scenario 140 of multiplexing the short PUCCH and the PUSCH. As showed in FIG. 10, the UE may be configured to multiplex the short PUCCH and the PUSCH in slot 141 by frequency division multiplexing (FDM). Specifically, slot 141 may comprise 14 OFDM symbols in time domain. The PUSCH in this example is scheduled in 14 OFDM symbols of slot 141. The short PUCCH is scheduled in the last OFDM symbol of slot 141. The time duration of the PUSCH and the time duration of the short PUCCH are different but may be overlapped in a part of slot 141 (e.g., overlapped in the last OFDM symbol of slot 141). However, the short PUCCH and the PUSCH are multiplexed in non-overlapping PRBs or REs. The PUSCH may be scheduled in a first set of sub-carriers and the short PUCCH may be scheduled in a second set of sub-carriers in frequency domain. The first set of sub-carriers and the second set of sub-carriers may be different and non-overlapping. Accordingly, the short PUCCH and the PUSCH are multiplexed in different time duration and in non-overlapping PRBs. The UE may be further configured to transmit the multiplexed short PUCCH and PUSCH to the network apparatus.

Similarly, when the time duration of the PUSCH and the time duration of the short PUCCH are overlapped in a part of the slot, UE transmission power control should be further considered for the overlapped part of the slot. In the time duration where the UE is configured to transmit both the short PUCCH and the PUSCH. The UE may be configured to determine a first transmission power for the short PUCCH and a second transmission power for the PUSCH. Alternatively, the UE may be configured to determine a first weighting factor for the short PUCCH and a second weighting factor for the PUSCH. The first weighting factor may be greater than the second weighting factor. The UE may be configured to distribute the transmission power according to the first weighting factor and the second weighting factor.

FIG. 1D illustrates an example scenario 160 of multiplexing the short PUCCH and the PUSCH. As showed in FIG. 1D, the UE may be configured to multiplex the short PUCCH and the PUSCH in slot 161 by frequency division multiplexing (FDM). Specifically, slot 161 may comprise 14 OFDM symbols in time domain. The PUSCH in this example is scheduled in 14 OFDM symbols of slot 161. The short PUCCH is scheduled in the last OFDM symbol of slot 161. The time duration of the PUSCH and the time duration of the short PUCCH are different but may be overlapped in a part of slot 161 (e.g., overlapped in the last OFDM symbol of slot 161). In this example, the short PUCCH and the PUSCH are multiplexed in overlapping PRBs or REs. The PUSCH may be scheduled in a first set of sub-carriers and the short PUCCH may be scheduled in a second set of sub-carriers in frequency domain. The first set of sub-carriers and the second set of sub-carriers may be overlapped. In other words, the time-frequency region of the short PUCCH is overlapped with a part of the time-frequency region of the PUSCH. Accordingly, the short PUCCH and the PUSCH are multiplexed in different time duration and in overlapping PRBs. The UE may be further configured to transmit the multiplexed short PUCCH and PUSCH to the network apparatus.

When the short PUCCH and the PUSCH are multiplexed in overlapping PRBs or REs, RE mapping schemes should be further considered. Specifically, the UE may be configured to perform rate-matching for the PUSCH to avoid an overlapping PRB when the short PUCCH and the PUSCH are multiplexed in the overlapping PRB. Since the short PUCCH may be more important than the PUSCH, when performing rate-matching for the PUSCH, the UE may be configured not to schedule the data bits of the PUSCH in the time-frequency region of the short PUCCH (i.e., the overlapping PRB). Alternatively, the UE may be configured to puncture the PUSCH in an overlapping PRB when the short PUCCH and the PUSCH are multiplexed in the overlapping PRB. The UE may be configured to schedule the data bits of the PUSCH in the time-frequency region of the PUSCH firstly and may further be configured to puncture the data bits of the PUSCH in the time-frequency region of the short PUCCH (i.e., the overlapping PRB). Alternatively, the UE may be configured to superpose the short PUCCH and the PUSCH when the short PUCCH and the PUSCH are multiplexed in an overlapping PRB. The UE may be configured to schedule both the data bits of the PUSCH and the data bits of the short PUCCH in the time-frequency region of the overlapping PRB.

In some implementations, the short PUCCH and the PUSCH from different UEs may also be multiplexed. Specifically, the network apparatus may configure different UEs to transmit the short PUCCH and the PUSCH in the same slot. For example, the short PUCCH may be transmitted from a first UE and the PUSCH may be transmitted from a second UE. The short PUCCH and the PUSCH may be multiplexed by any one of schemes showed in FIG. 1A-1D. In another example, the short PUCCH and the PUSCH transmitted from a first UE may be collided with the short PUCCH and the PUSCH transmitted from a second UE. The network apparatus may be further configured to deal with the collision from different UEs. The collision between different UEs should be transparent to the UEs.

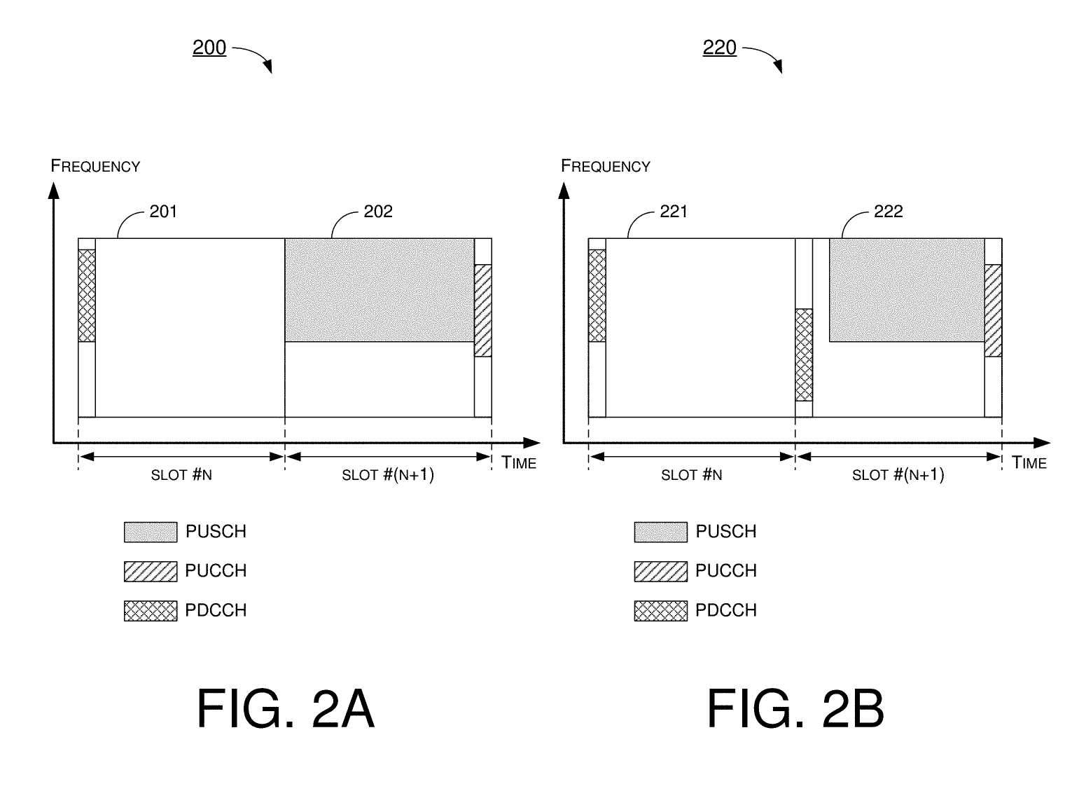

FIGS. 2A and 2B illustrate example scenarios 200 and 220 under schemes in accordance with implementations of the present disclosure. Scenarios 200 and 220 involve a user equipment (UE) and a network apparatus (e.g., a base station), which may be a part of a wireless network (e.g., a LTE network, a LTE-Advanced network, a LTE-Advanced Pro network, a 5th Generation (5G) network, a New Radio (NR) network or an Internet of Things (IoT) network). The UE may be configured receive downlink signals from the network apparatus. The downlink signals may comprise control information such as, for example and without limitation, a physical downlink control channel (PDCCH), a physical downlink shared channel (PDSCH) or higher layer signaling (e.g., radio resource control (RRC) layer signaling). The downlink signals may be used to carry the time-frequency information of at least one of the PUSCH, the short PUCCH and the PDSCH. For example, the downlink signal may indicate whether the PUSCH can use the last few symbols of a slot or not.

FIG. 2A illustrates an example scenario 200 of configuring the PUSCH according to the PDCCH. As showed in FIG. 2A, the UE may be configured to receive the PDCCH in slot 201. The PDCCH may indicate an ending symbol index of the PUSCH in slot 202. The PDCCH may further indicate that the PUSCH scheduling is applied to which slot. For example, slot 202 may comprise 14 OFDM symbols in time domain and the symbol index may start from 0 to 13. The PDCCH may indicate that the ending symbol index of the PUSCH in slot 202 is 12. After receiving the PDCCH, the UE may schedule the PUSCH in the first 13 OFDM symbols (i.e., symbol index 0 to 12) of slot 202 and reserve the last OFDM symbol of slot 202 for the short PUCCH. The PDCCH may further carry the information of sub-carriers in frequency domain. The UE may further schedule the sub-carriers for the PUSCH and the short PUCCH according to the PDCCH.

In some implementations, the control information may comprise the configurations of at least one of the PUSCH, the short PUCCH, the SRS, the PDCCH and the PDSCH. The control information may be dynamically indicated by physical layer signaling or L1 signaling. For example, the control information may be indicated by a scheduling downlink control indicator (DCI). The scheduling DCI may be an UE-specific DCI for a specific UE or a group-common DCI for a plurality of UEs. The physical layer signaling or L1 signaling may carry explicit information such as, for example and without limitation, an indication of ending symbol index of the PUSCH. Alternatively, the physical layer signaling or L1 signaling may carry implicit information such as, for example and without limitation, an indication of starting symbol index of the PUSCH and a number of symbols used for the PUSCH, or a joint encoding indication of starting symbol index and ending symbol index of the PUSCH.

In some implementations, the downlink control information may be configured by higher layer signaling (e.g., RRC signaling). For example, the configurations of at least one of the PUSCH, the short PUCCH, the SRS, the PDCCH and the PDSCH may be configured by the RRC signaling. The resource allocation for at least one of the PUSCH, the short PUCCH, the SRS, the PDCCH and the PDSCH may also be configured by the RRC signaling. In some implementations, the downlink control information may be configured by the combinations of higher layer signaling and physical layer signaling/L1 signaling. For example, the RRC signaling may be used to inform the UE the possible configurations. The physical layer signaling or L1 signaling may further be used to indicate the UE which configuration is enabled or activated.

In some implementations, the control information may indicate the time duration of at least one of the PUSCH, the short PUCCH, the SRS, the PDCCH and the PDSCH in a TTI. After receiving the control information, the UE may be able to determine the time duration of at least one of the PUSCH, the short PUCCH, the SRS, the PDCCH and the PDSCH in the TTI. The UE may be configured to schedule the TTI according to the determined time duration. For example, the control information may indicate at least one of a starting symbol index, an ending symbol index and number of symbols of at least one of the PUSCH, the short PUCCH, the SRS, the PDCCH and the PDSCH. The at least one of the starting symbol index, the ending symbol index and the number of symbols of at least one of the PUSCH, the short PUCCH, the SRS, the PDCCH and the PDSCH may be indicated in separate fields or jointly encoded in one field. The control information may indicate the time duration of at least one of the PUSCH, the short PUCCH, the SRS, the PDCCH and the PDSCH by commonly indicating multiple TTIs, separately indicating each TTI or group-wise indicating the group of TTIs. In view of the time duration of at least one of the PUSCH, the short PUCCH, the SRS, the PDCCH and the PDSCH, the UE may be configured to multiplex at least two of the PUSCH, the short PUCCH, the SRS, the PDCCH and the PDSCH in a TTI. For example, the UE may be configured to multiplex at least one the short PUCCH, the SR and the PDCCH with at least one of the PUSCH and the PDSCH in a TTI.

FIG. 2B illustrates an example scenario 220 of configuring the PUSCH according to the PDCCH. As showed in FIG. 2B, the UE may be configured to receive the PDCCH in slot 221. The PDCCH may indicate a starting symbol index and a number of symbols used for the PUSCH in slot 222. The PDCCH may further indicate that the PUSCH scheduling is applied to which slot. For example, slot 222 may comprise 14 OFDM symbols in time domain and the symbol index may start from 0 to 13. The PDCCH may indicate that the starting symbol index of the PUSCH in slot 202 is 2 and the number of symbols used for the PUSCH in slot 222 is 11. After receiving the PDCCH, the UE may schedule the PUSCH from symbol index 2 to 12 of slot 222 and reserve the last OFDM symbol of slot 222 for the short PUCCH. In this example, since the first OFDM symbol is reserved for the PDCCH in slot 222 and the second OFDM symbol is reserved as a transition gap, the PUSCH is started from the third OFDM symbol of slot 222. The PDCCH of slot 222 may carry information for other slots or other UEs.

In some implementations, the PDCCH may separately indicate a starting symbol index and an ending symbol index of the PUSCH. For example, the network apparatus may use one-bit field in the scheduling DCI to indicate a starting symbol index set such as, for example and without limitation, {0, 2}. When the one-bit field indicates “0”, it means the starting symbol index is 0. When the one-bit field indicates “1”, it means the starting symbol index is 2. The network apparatus may also use one-bit field in the scheduling DCI to indicate an ending symbol index set such as, for example and without limitation, {12, 13}. When the one-bit field indicates “0”, it means the ending symbol index is 12. When the one-bit field indicates “1”, it means the ending symbol index is 13. The correspondence between the one-bit field indication and the starting symbol index set and/or the ending symbol index set may be configured by higher layer signaling (e.g., RRC signaling).

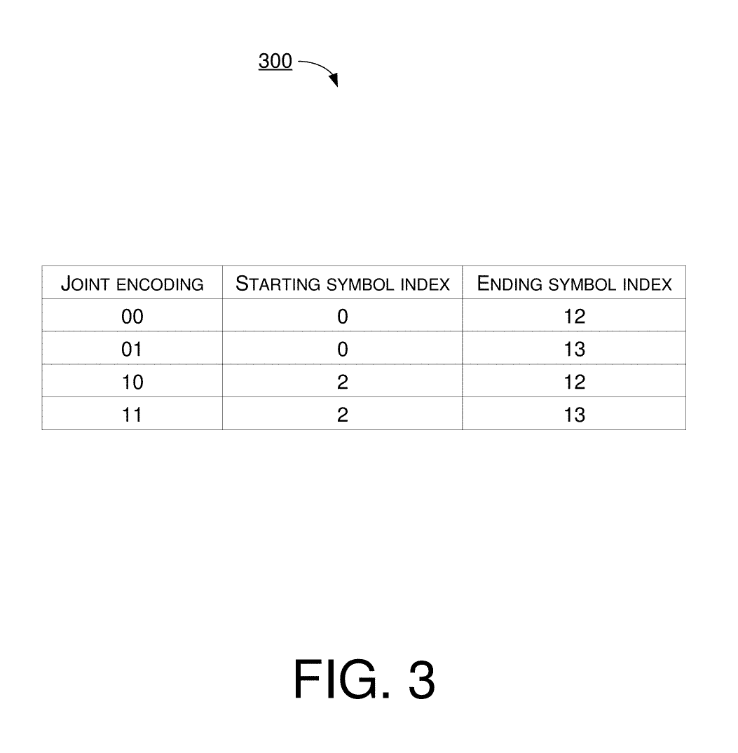

In some implementations, the starting symbol index and the ending symbol index of the PUSCH may be jointly encoded and indicated. FIG. 3 illustrates an example table 300 of joint encoding of the starting symbol index and the ending symbol index. As showed in FIG. 3, the combinations of the starting symbol index and the ending symbol index are encoded by two bits indication. For example, the joint encoding indication “00” represents the starting symbol index is 0 and the ending symbol index is 12. The joint encoding indication “01” represents the starting symbol index is 0 and the ending symbol index is 13. The joint encoding indication “10” represents the starting symbol index is 2 and the ending symbol index is 12. The joint encoding indication “11” represents the starting symbol index is 2 and the ending symbol index is 13. The joint encoding combinations may be configured by higher layer signaling (e.g., RRC signaling). The two bits indication may be indicated by physical layer signaling or L1 signaling.

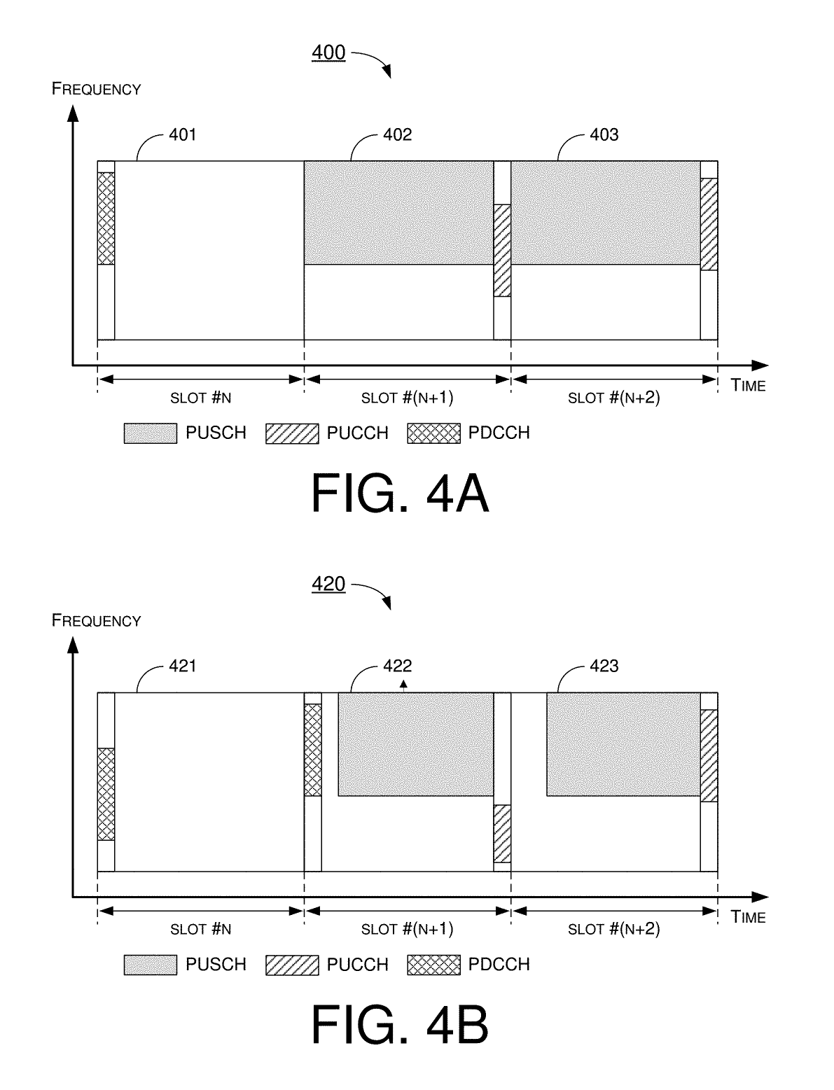

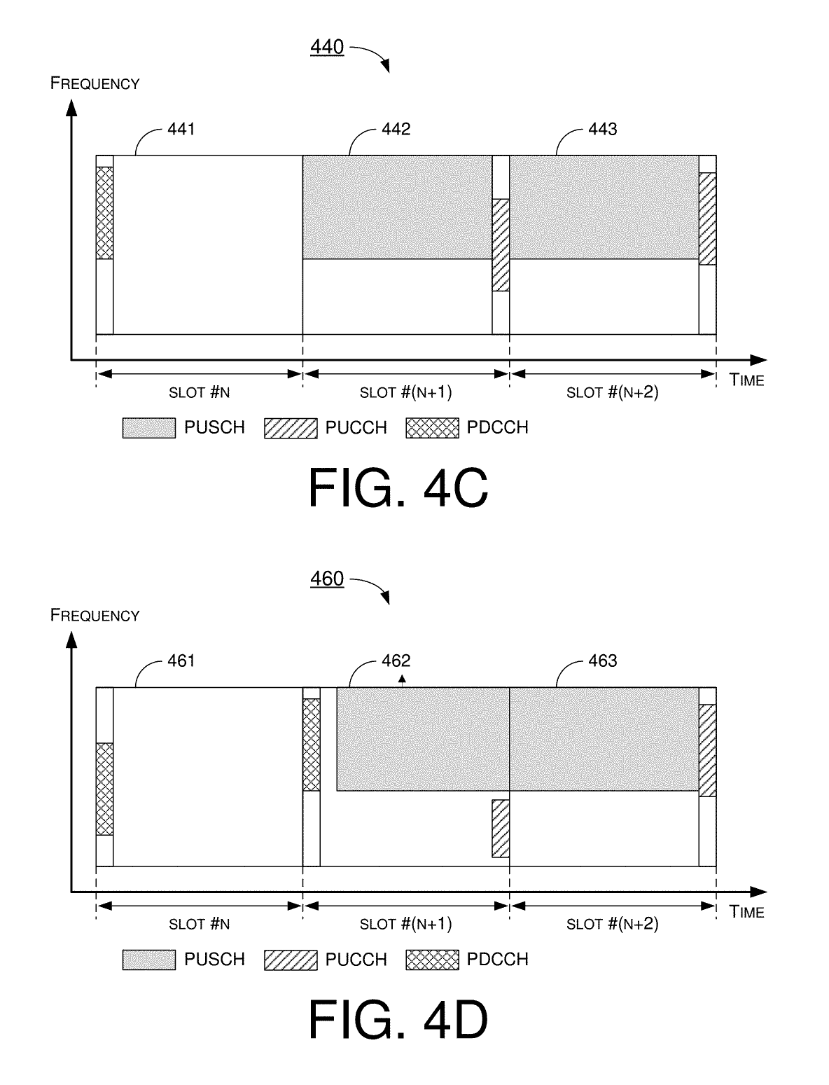

FIGS. 4A-4D illustrate example scenarios 400, 420, 440 and 460 under schemes in accordance with implementations of the present disclosure. Scenarios 400, 420, 440 and 460 involve a user equipment (UE) and a network apparatus (e.g., a base station), which may be a part of a wireless network (e.g., a LTE network, a LTE-Advanced network, a LTE-Advanced Pro network, a 5th Generation (5G) network, a New Radio (NR) network or an Internet of Things (IoT) network). The aforementioned schemes for single slot scheduling of the PUSCH and/or the short PUCCH may also be applied to multiple slots scheduling. The starting symbol index and/or the ending symbol index of at least one of the PUSCH, the short PUCCH and the PDSCH in multiple slots may be indicated by the PDCCH or the scheduling DCI in one slot.

FIG. 4A illustrates an example scenario 400 of multiple slots scheduling of the PUSCH according to the PDCCH. As showed in FIG. 4A, the UE may be configured to receive the PDCCH in slot 401. The PDCCH may commonly indicate the starting symbol index and the ending starting symbol index of the PUSCH in slot 402 and slot 403. For example, the PDCCH in slot 401 may indicate that the starting symbol index of the PUSCH is 0 and the ending symbol index of the PUSCH is 12. The PDCCH may further indicate that the PUSCH scheduling should be applied to which slots (e.g., slot 402 and slot 403). After receiving the PDCCH, the UE may schedule the PUSCH from symbol index 0 to 12 and reserve the last OFDM symbol for the short PUCCH in slot 402 and slot 403. Thus, the PUSCH in both slot 402 and slot 403 are commonly scheduled by the PDCCH in slot 401. In another example, how many slots the PDCCH should apply to may be configured by higher layer signaling (e.g., RRC signaling). The PDCCH may solely carry the information of the starting symbol index and/or the ending symbol index of the PUSCH.

FIG. 4B illustrates an example scenario 420 of multiple slots scheduling of the PUSCH according to the PDCCH. As showed in FIG. 4B, the UE may be configured to receive the PDCCH in slot 421. The PDCCH may commonly indicate the starting symbol index and the ending starting symbol index of the PUSCH in slot 422 and slot 423. For example, the PDCCH in slot 421 may indicate that the starting symbol index of the PUSCH is 2 and the ending symbol index of the PUSCH is 12. The PDCCH may further indicate that the PUSCH scheduling is applied to which slots (e.g., slot 422 and slot 423). After receiving the PDCCH, the UE may schedule the PUSCH from symbol index 2 to 12 and reserve the last OFDM symbol for the short PUCCH in slot 422 and slot 423. In this example, since the first OFDM symbol is reserved for the PDCCH in slot 422 and the second OFDM symbol is reserved as a transition gap, the PUSCH is started from the third OFDM symbol of slot 422. The PDCCH of slot 422 may carry information for other slots or other UEs. Due to that the PDCCH in slot 421 is two slot scheduling and is applied to slot 422 and slot 423, the PUSCH of slot 423 is also started form symbol index 2 although there is no PDCCH scheduled in slot 423. Similarly, how many slots the PDCCH should apply to may be configured by higher layer signaling (e.g., RRC signaling). The PDCCH only carry the information of the starting symbol index and/or the ending symbol index of the PUSCH.

FIG. 4C illustrates an example scenario 440 of multiple slots scheduling of the PUSCH according to the PDCCH. As showed in FIG. 4C, the UE may be configured to receive the PDCCH in slot 441. The PDCCH may separately indicate the starting symbol index and the ending starting symbol index of the PUSCH in slot 442 and slot 443. The PDCCH may further indicate that the PUSCH scheduling should be applied to which slots. For example, the PDCCH in slot 441 may indicate that the starting symbol index of the PUSCH is 0 and the ending symbol index of the PUSCH is 12 for slot 442. The PDCCH in slot 441 may further indicate that the starting symbol index of the PUSCH is 0 and the ending symbol index of the PUSCH is 12 for slot 443. After receiving the PDCCH, the UE may schedule the PUSCH from symbol index 0 to 12 and reserve the last OFDM symbol for the short PUCCH in slot 442 and slot 443. Thus, the PUSCH in slot 442 and slot 443 are separately scheduled by the PDCCH in slot 441. In this scheme, the PDCCH may have to carry more information for the PUSCH configurations in each slot.

FIG. 4D illustrates an example scenario 460 of multiple slots scheduling of the PUSCH according to the PDCCH. As showed in FIG. 4D, the UE may be configured to receive the PDCCH in slot 461. The PDCCH may separately indicate the starting symbol index and the ending starting symbol index of the PUSCH in slot 462 and slot 463. The PDCCH may further indicate that the PUSCH scheduling is applied to which slots. For example, the PDCCH in slot 461 may indicate that the starting symbol index of the PUSCH is 2 and the ending symbol index of the PUSCH is 13 for slot 462. The PDCCH in slot 461 may further indicate that the starting symbol index of the PUSCH is 0 and the ending symbol index of the PUSCH is 12 for slot 463. After receiving the PDCCH, the UE may schedule the PUSCH from symbol index 2 to 13 in slot 462 and schedule the PUSCH from symbol index 0 to 12 and reserve the last OFDM symbol for the short PUCCH in slot 463. In this example, since the configurations of the PDCCH and the short PUCCH in slot 462 and slot 463 are different, the PDCCH in slot 461 may be able to separately indicate the different PUSCH configurations for slot 462 and slot 463. In this scheme, the resource allocation for each slot may be more efficient and more flexible, but the PDCCH may have to carry more information for the PUSCH configurations in each slot.

In some implementations, the multiple slots scheduling may also be implemented by slot-group-wise indication. For example, the PDCCH in one slot may be used to indicate the PUSCH configurations for a group of slots. The PDCCH may commonly indicate the same configuration for all slots in the group. The PDCCH may also separately indicate different configurations for each slot in the group. How many slots or which slots should be included in a group may be configured by higher layer signaling (e.g., RRC signaling).

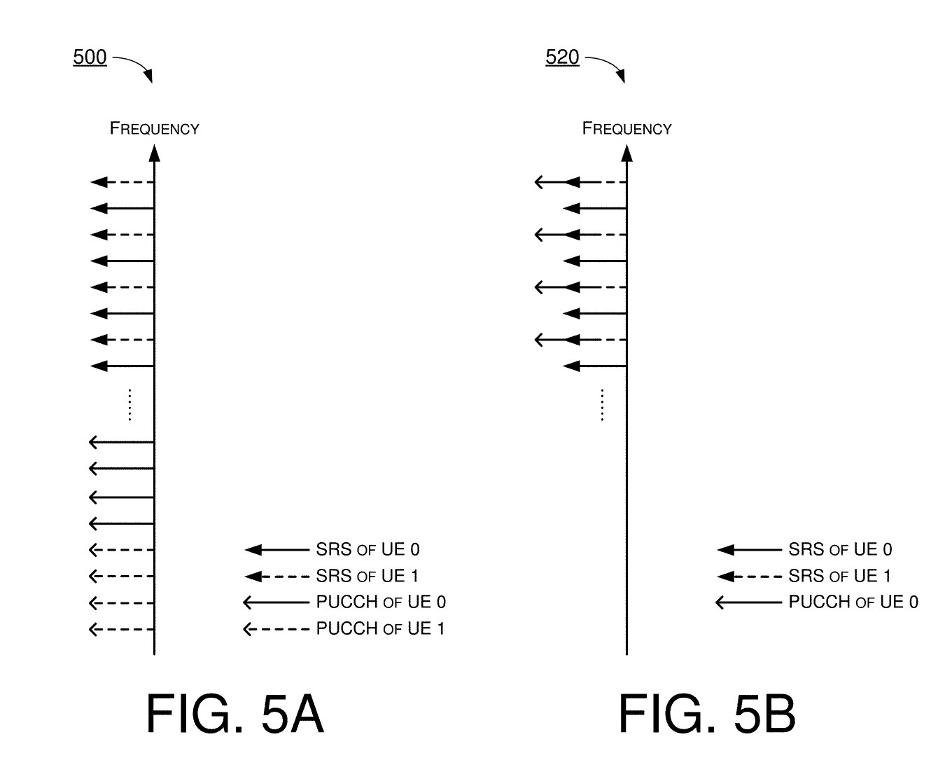

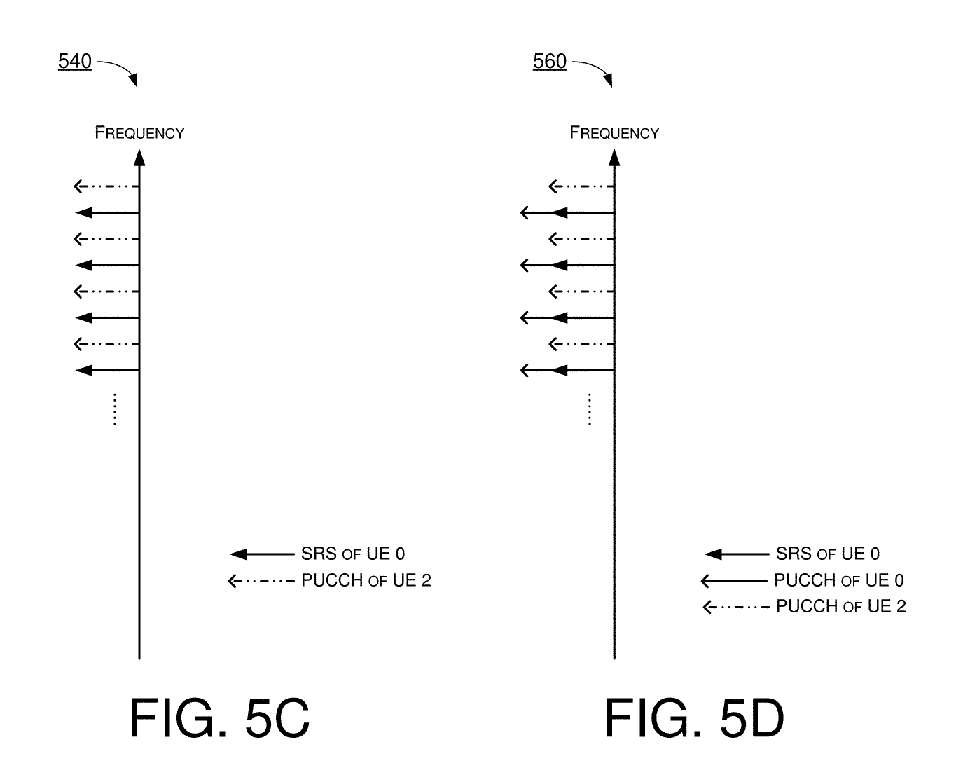

FIGS. 5A-5D illustrate example scenarios 500, 520, 540 and 560 under schemes in accordance with implementations of the present disclosure. Scenarios 500, 520, 540 and 560 involve a user equipment (UE) and a network apparatus (e.g., a base station), which may be a part of a wireless network (e.g., a LTE network, a LTE-Advanced network, a LTE-Advanced Pro network, a 5th Generation (5G) network, a New Radio (NR) network or an Internet of Things (IoT) network). In addition to multiplexing the short PUCCH with the PUSCH, the short PUCCH may also be multiplexed with the SRS. The SRS is transmitted from the UE to the network apparatus for the network apparatus to perform channel estimation or measure signal quality. For example, the network apparatus may be configured to measure the reference signal received power (RSRP) according to the received SRS. The short PUCCH and the SRS may be multiplexed by time division multiplexing (TDM), frequency division multiplexing (FDM) or code division multiplexing (CDM).

FIG. 5A illustrates an example scenario 500 of multiplexing the short PUCCH and the SRS. As showed in FIG. 5A, the UE may be configured to multiplex the short PUCCH and the SRS in a TTI by FDM. The TTI may be an OFDM symbol. For example, the short PUCCH of a first UE (e.g., UE 0) and the SRS of the first UE (e.g., UE 0) may be multiplexed within the same OFDM symbol and in different sub-carriers. The network apparatus may configure UE 0 to transmit its SRS in a first set of sub-carriers and transmit its short PUCCH in a second set of sub-carriers. The first set of sub-carriers may be different from the second set of sub-carriers. The short PUCCH and the SRS of UE 0 may be scheduled or multiplexed in continuous sub-carriers or in non-continuous sub-carriers. In addition, the short PUCCH and the SRS of different UEs may also be multiplexed in an OFDM symbol. As showed in FIG. 5A, the short PUCCH and the SRS of a second UE (e.g., UE 1) are also multiplexed with the short PUCCH and the SRS of the first UE (e.g., UE 0) within the same OFDM symbol and in different sub-carriers. The short PUCCH and the SRS of different UEs may be scheduled or multiplexed in continuous sub-carriers or in non-continuous sub-carriers. The network apparatus may configure UE 0 to transmit its SRS and short PUCCH in a third set of sub-carriers and configure UE 1 to transmit its SRS and short PUCCH in a fourth set of sub-carriers. The third set of sub-carriers may be different from the fourth set of sub-carriers.

FIG. 5B illustrates an example scenario 520 of multiplexing the short PUCCH and the SRS. As showed in FIG. 5B, the short PUCCH and the SRS may be multiplexed in an OFDM symbol by CDM. For example, the SRS of a first UE (e.g., UE 0) and the SRS of a second UE (e.g., UE 1) may be multiplexed within the same OFDM symbol and in different sub-carriers. The short PUCCH of the first UE (e.g., UE 0) may be multiplexed or superposed with the SRS of the second UE (e.g., UE 1) in the same sub-carriers by CDM. The short PUCCH and the SRS may be multiplexed or scheduled in an overlapping physical resource block or in non-overlapping physical resource blocks. The network apparatus may configure UE 0 to transmit its short PUCCH in a first set of sub-carriers and configure UE 1 to transmit its SRS in a second set of sub-carriers. The first set of sub-carriers may be identical to or overlapped with the second set of sub-carriers.

FIG. 5C illustrates an example scenario 540 of multiplexing the short PUCCH and the SRS. As showed in FIG. 5C, the UE may be configured to schedule the short PUCCH in non-continuous sub-carriers. For example, the short PUCCH of a third UE (e.g., UE 2) may be scheduled in non-continuous sub-carriers and multiplexed with the SRS of the first UE (e.g., UE 0) in an OFDM symbol by FDM. The short PUCCH of UE 2 and the SRS of UE 0 are interlaced in continuous sub-carriers. The network apparatus may configure UE 2 to transmit its short PUCCH in a first set of sub-carriers and configure UE 0 to transmit its SRS in a second set of sub-carriers. The first set of sub-carriers may be interlaced with the second set of sub-carriers in continuous sub-carriers or in non-continuous sub-carriers. The first set of sub-carriers may be different from the second set of sub-carriers.

FIG. 5D illustrates an example scenario 560 of multiplexing the short PUCCH and the SRS. As showed in FIG. 5D, the UE may be configured to multiplex the short PUCCH and the SRS in an OFDM symbol by CDM. The short PUCCH of the first UE (e.g., UE 0) may be multiplexed or superposed with the SRS of the first UE (e.g., UE 0) in the same sub-carriers by CDM. The short PUCCH and the SRS may be multiplexed or scheduled in an overlapping physical resource block or in non-overlapping physical resource blocks. The network apparatus may configure UE 0 to transmit its short PUCCH in a first set of sub-carriers and transmit its SRS in a second set of sub-carriers. The first set of sub-carriers may be identical to or overlapped with the second set of sub-carriers.

### Illustrative Implementations

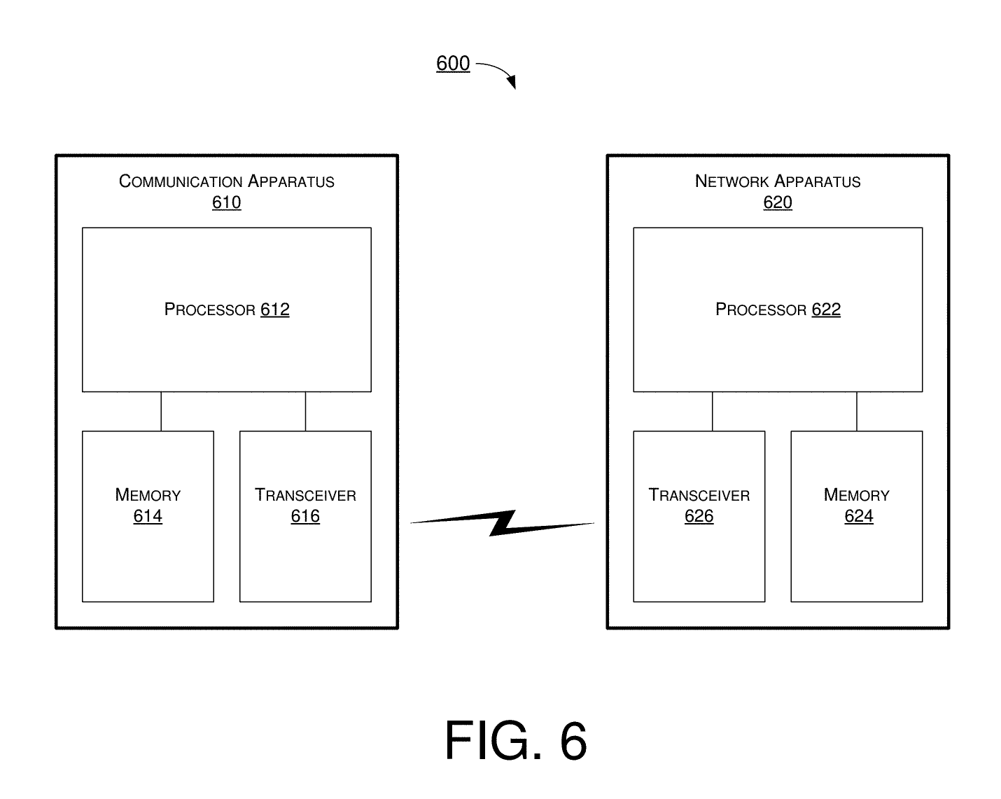

FIG. 6 illustrates an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to multiplexing physical uplink control channels with respect to user equipment in wireless communications, including scenarios 100, 120, 140, 160, 200, 220, 400, 420, 440, 460, 500, 520, 540 and 560 described above as well as processes 700 and 800 described below.

Communication apparatus 610 may be a part of an electronic apparatus, which may be a user equipment (UE) such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, or one or more complex-instruction-set-computing (CISC) processors. Communication apparatus 610 may include at least some of those components shown in FIG. 6 such as a processor 612, for example. communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a base station, a small cell, a router or a gateway. For instance, network apparatus 620 may be implemented in an eNodeB in a LTE, LTE-Advanced or LTE-Advanced Pro network or in a gNB in a 5G, NR or IoT network. Alternatively, network apparatus 620 may be implemented in the form of one or more IC chips such as, for example and without limitation, one or more single-core processors, one or more multi-core processors, or one or more CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including power consumption reduction in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

In some implementations, processor 612 may be configured to transmit, via transceiver 616, uplink signals to network apparatus 620. The uplink signals may comprise, for example and without limitation, a physical uplink control channel (PUCCH), a physical uplink shared channel (PUSCH) or a sounding reference signal (SRS). In NR communication system, a short PUCCH is newly introduced. The short PUCCH may occupy, for example and without limitation, one, two or only few OFDM symbols. In order to transmit the short PUCCH in more efficient and flexible way, processor 612 may be configured to multiplex the short PUCCH with other channels.

In some implementations, processor 612 may be configured to multiplex the short PUCCH and the PUSCH in a transmission time interval (TTI) by time division multiplexing (TDM). A TTI is a scheduling unit of a communication network which may be, for example and without limitation, a transmission sub-frame in a LTE network or a transmission slot in a NR network. For example, a slot may comprise 14 OFDM symbols in time domain. The short PUCCH may occupy only one OFDM symbol. Processor 612 may be configured to schedule the PUSCH in the first 13 OFDM symbols of the slot and schedule the short PUCCH in the last OFDM symbol of the slot. Accordingly, processor 612 may multiplex the short PUCCH and the PUSCH in different time duration within one slot. Further, processor 612 may schedule the PUSCH in a first set of sub-carriers and schedule the short PUCCH in a second set of sub-carriers in frequency domain. The first set of sub-carriers and the second set of sub-carriers may be different or identical. Processor 612 may be further configured to transmit, via transceiver 616, the multiplexed short PUCCH and PUSCH to network apparatus 620.

In some implementations, processor 612 may be configured to multiplex the short PUCCH and the PUSCH a slot by frequency division multiplexing (FDM). For example, a slot may comprise 14 OFDM symbols in time domain. The PUSCH may be one-symbol PUSCH and processor 612 may schedule the PUSCH in the last OFDM symbol of the slot. Processor 612 may be configured to schedule the short PUCCH in the last OFDM symbol of the slot. Processor 612 may multiplex the short PUCCH and the PUSCH in non-overlapping physical resource blocks (PRBs) or resource elements (REs). Processor 612 may schedule the PUSCH in a first set of sub-carriers and schedule the short PUCCH in a second set of sub-carriers in frequency domain. The first set of sub-carriers and the second set of sub-carriers may be different and non-overlapping. Accordingly, processor 612 may multiplex the short PUCCH and the PUSCH in the same time duration and in non-overlapping PRBs. Processor 612 may be further configured to transmit, via transceiver 616, the multiplexed short PUCCH and PUSCH to network apparatus 620.

In some implementations, communication apparatus 610 may be configured with a maximum transmission power and is not allowed to transmit signals over the maximum transmission power. When communication apparatus 610 is configured to transmit the short PUCCH and the PUSCH at the same time, the transmission power may need to be distributed between the short PUCCH and the PUSCH. For example, processor 612 may be configured to determine a first transmission power for the short PUCCH and determine a second transmission power for the PUSCH when the short PUCCH and the PUSCH are multiplexed in the same time duration. Since the short PUCCH may be more important than the PUSCH, processor 612 may transmit the short PUCCH with major power and transmit the PUSCH with remaining power (e.g., the first transmission power is greater than the second transmission power). In another example, processor 612 may be configured to determine a first weighting factor for the short PUCCH and determine a second weighting factor for the PUSCH. The first weighting factor may be greater than the second weighting factor. Processor 612 may be configured to distribute the transmission power according to the first weighting factor and the second weighting factor.

In some implementations, processor 612 may be configured to multiplex the short PUCCH and the PUSCH in a slot by frequency division multiplexing (FDM). For example, a slot may comprise 14 OFDM symbols in time domain. Processor 612 may schedule the PUSCH in 14 OFDM symbols of the slot. Processor 612 may schedule the short PUCCH in the last OFDM symbol of the slot. The time duration of the PUSCH and the time duration of the short PUCCH are different but may be overlapped in a part of the slot (e.g., overlapped in the last OFDM symbol of the slot). Processor 612 may multiplex the short PUCCH and the PUSCH in non-overlapping PRBs or REs. Processor 612 may schedule the PUSCH in a first set of sub-carriers and schedule the short PUCCH in a second set of sub-carriers in frequency domain. The first set of sub-carriers and the second set of sub-carriers may be different and non-overlapping. Accordingly, processor 612 may multiplex the short PUCCH and the PUSCH in different time duration and in non-overlapping PRBs. Processor 612 may be further configured to transmit, via transceiver 616, the multiplexed short PUCCH and PUSCH to network apparatus 620.

In some implementations, processor 612 may be configured to multiplex the short PUCCH and the PUSCH in a slot by frequency division multiplexing (FDM). For example, a slot may comprise 14 OFDM symbols in time domain. Processor 612 may schedule the PUSCH in 14 OFDM symbols of the slot. Processor 612 may schedule the short PUCCH in the last OFDM symbol of the slot. The time duration of the PUSCH and the time duration of the short PUCCH are different but may be overlapped in a part of the slot (e.g., overlapped in the last OFDM symbol of the slot). Processor 612 may multiplex the short PUCCH and the PUSCH in overlapping PRBs or REs. Processor 612 may schedule the PUSCH in a first set of sub-carriers and schedule the short PUCCH in a second set of sub-carriers in frequency domain. The first set of sub-carriers and the second set of sub-carriers may be overlapped. In other words, the time-frequency region of the short PUCCH is overlapped with a part of the time-frequency region of the PUSCH. Accordingly, processor 612 may multiplex the short PUCCH and the PUSCH in different time duration and in overlapping PRBs. Processor 612 may be further configured to transmit, via transceiver 616, the multiplexed short PUCCH and PUSCH to network apparatus 620.

In some implementations, when the short PUCCH and the PUSCH are multiplexed in overlapping PRBs or REs, RE mapping schemes should be further considered. For example, processor 612 may be configured to perform rate-matching for the PUSCH to avoid an overlapping PRB when the short PUCCH and the PUSCH are multiplexed in the overlapping PRB. Since the short PUCCH may be more important than the PUSCH, when performing rate-matching for the PUSCH, processor 612 may be configured not to schedule the data bits of the PUSCH in the time-frequency region of the short PUCCH (i.e., the overlapping PRB). Alternatively, processor 612 may be configured to puncture the PUSCH in an overlapping PRB when the short PUCCH and the PUSCH are multiplexed in the overlapping PRB. Processor 612 may be configured to schedule the data bits of the PUSCH in the time-frequency region of the PUSCH firstly and may further be configured to puncture the data bits of the PUSCH in the time-frequency region of the short PUCCH (i.e., the overlapping PRB). Alternatively, processor 612 may be configured to superpose the short PUCCH and the PUSCH when the short PUCCH and the PUSCH are multiplexed in an overlapping PRB. Processor 612 may be configured to schedule both the data bits of the PUSCH and the data bits of the short PUCCH in the time-frequency region of the overlapping PRB.

In some implementations, the short PUCCH and the PUSCH from different UEs may also be multiplexed. Specifically, network apparatus 620 may configure different UEs to transmit the short PUCCH and the PUSCH in the same slot. For example, the short PUCCH may be transmitted from a first UE and the PUSCH may be transmitted from a second UE. In another example, the short PUCCH and the PUSCH transmitted from a first UE may be collided with the short PUCCH and the PUSCH transmitted from a second UE. Network apparatus 620 may be further configured to deal with the collision from different UEs. The collision between different UEs should be transparent to the UEs.

In some implementations, processor 612 may be configured receive, via transceiver 616, downlink signals from network apparatus 620. The downlink signals may comprise control information such as, for example and without limitation, a physical downlink control channel (PDCCH), a physical downlink shared channel (PDSCH) or higher layer signaling (e.g., radio resource control (RRC) layer signaling). Network apparatus 620 may use the downlink signals to carry the time-frequency information of at least one of the PUSCH, the short PUCCH and the PDSCH. For example, processor 622 may use the downlink signal to indicate whether the PUSCH can use the last few symbols of a slot or not.

In some implementations, processor 612 may be configured to receive the PDCCH in a first slot from network apparatus 620. Processor 622 may use the PDCCH to indicate an ending symbol index of the PUSCH in a second slot. Processor 622 may further use the PDCCH to indicate that the PUSCH scheduling is applied to which slot. For example, the second slot may comprise 14 OFDM symbols in time domain and the symbol index may start from 0 to 13. The PDCCH may indicate that the ending symbol index of the PUSCH in the second slot is 12. After receiving the PDCCH, processor 612 may schedule the PUSCH in the first 13 OFDM symbols (i.e., symbol index 0 to 12) of the second slot and reserve the last OFDM symbol of the second slot for the short PUCCH. Processor 622 may further use the PDCCH to carry the information of sub-carriers in frequency domain. Processor 612 may further schedule the sub-carriers for the PUSCH and the short PUCCH according to the PDCCH.

In some implementations, processor 622 may dynamically indicate the PUSCH and/or the short PUCCH configurations by physical layer signaling or L1 signaling. For example, processor 622 may indicate the PUSCH and/or the short PUCCH configurations by a scheduling downlink control indicator (DCI). The scheduling DCI may be an UE-specific DCI for a specific UE or a group-common DCI for a plurality of UEs. Processor 622 may use the physical layer signaling or L1 signaling to carry explicit information such as, for example and without limitation, an indication of ending symbol index of the PUSCH. Alternatively, processor 622 may use the physical layer signaling or L1 signaling to carry implicit information such as, for example and without limitation, an indication of starting symbol index of the PUSCH and a number of symbols used for the PUSCH, or a joint encoding indication of starting symbol index and ending symbol index of the PUSCH.

In some implementations, processor 622 may configure the downlink control information by higher layer signaling (e.g., RRC signaling). For example, the configurations of at least one of the PUSCH, the short PUCCH and the PDSCH may be configured by the RRC signaling. Processor 622 may also configure the resource allocation for the short PUCCH and the PUSCH by the RRC signaling. In some implementations, processor 622 may configure the downlink control information by the combinations of higher layer signaling and physical layer signaling/L1 signaling. For example, processor 622 may use the RRC signaling to inform the UE the possible configurations. Processor 622 may further use the physical layer signaling or L1 signaling to indicate the UE which configuration is enabled or activated.

In some implementations, processor 612 may be configured to receive the PDCCH in a first slot from network apparatus 620. Processor 622 may use the PDCCH to indicate a starting symbol index and a number of symbols used for the PUSCH in a second slot. Processor 622 may further use the PDCCH to indicate that the PUSCH scheduling is applied to which slot. For example, the second slot may comprise 14 OFDM symbols in time domain and the symbol index may start from 0 to 13. Processor 622 may use the PDCCH to indicate that the starting symbol index of the PUSCH in the second slot is 2 and the number of symbols used for the PUSCH in the second slot is 11. After receiving the PDCCH, processor 612 may schedule the PUSCH from symbol index 2 to 12 of the second slot and reserve the last OFDM symbol of the second slot for the short PUCCH.

In some implementations, processor 622 may use the PDCCH to separately indicate a starting symbol index and an ending symbol index of the PUSCH. For example, processor 622 may use one-bit field in the scheduling DCI to indicate a starting symbol index set such as, for example and without limitation, {0, 2}. When the one-bit field indicates “0”, it means the starting symbol index is 0. When the one-bit field indicates “1”, it means the starting symbol index is 2. Processor 622 may also use one-bit field in the scheduling DCI to indicate an ending symbol index set such as, for example and without limitation, {12, 13}. When the one-bit field indicates “0”, it means the ending symbol index is 12. When the one-bit field indicates “1”, it means the ending symbol index is 13. Processor 622 may configure the correspondence between the one-bit field indication and the starting symbol index set and/or the ending symbol index set by higher layer signaling (e.g., RRC signaling).

In some implementations, processor 622 may jointly encode and indicate the starting symbol index and the ending symbol index of the PUSCH. Processor 622 may encode the combinations of the starting symbol index and the ending symbol index by two bits indication.

In some implementations, processor 622 may use the PDCCH or the scheduling DCI in one slot to indicate the starting symbol index and/or the ending symbol index of at least one of the PUSCH, the short PUCCH and the PDSCH for multiple slots.

In some implementations, processor 612 may be configured to receive the PDCCH in a first slot from network apparatus 620. Processor 622 may use the PDCCH to commonly indicate the starting symbol index and the ending starting symbol index of the PUSCH in a second slot and a third slot. For example, processor 622 may use the PDCCH in the first slot to indicate that the starting symbol index of the PUSCH is 0 and the ending symbol index of the PUSCH is 12. Processor 622 may further use the PDCCH to indicate that the PUSCH scheduling should be applied to which slots. After receiving the PDCCH, processor 612 may schedule the PUSCH from symbol index 0 to 12 and reserve the last OFDM symbol for the short PUCCH in slot 402 and slot 403. Thus, processor 622 may commonly schedule the PUSCH in both the second slot and the third slot by the PDCCH in the first slot. In another example, processor 622 may configure how many slots the PDCCH should be applied by higher layer signaling (e.g., RRC signaling). Processor 622 may use the PDCCH to solely carry the information of the starting symbol index and/or the ending symbol index of the PUSCH.

In some implementations, processor 612 may be configured to receive the PDCCH in a first slot from network apparatus 620. Processor 622 may use the PDCCH to separately indicate the starting symbol index and the ending starting symbol index of the PUSCH in a second slot and a third slot. Processor 622 may further use the PDCCH to indicate that the PUSCH scheduling should be applied to which slots. For example, processor 622 may use the PDCCH in the first slot to indicate that the starting symbol index of the PUSCH is 0 and the ending symbol index of the PUSCH is 12 for the second slot. Processor 622 may further use the PDCCH in the first slot to indicate that the starting symbol index of the PUSCH is 0 and the ending symbol index of the PUSCH is 12 for the third slot. After receiving the PDCCH, processor 612 may schedule the PUSCH from symbol index 0 to 12 and reserve the last OFDM symbol for the short PUCCH in the second slot and the third slot. Thus, processor 622 may separately schedule the PUSCH in the second slot and the third slot by the PDCCH in the first slot. In this scheme, processor 622 may configure the PDCCH to carry more information for the PUSCH configurations in each slot.

In some implementations, processor 622 may use slot-group-wise indication for the multiple slots scheduling. For example, processor 622 may use the PDCCH in one slot to indicate the PUSCH configurations for a group of slots. Processor 622 may use the PDCCH to commonly indicate the same configuration for all slots in the group. Processor 622 may also use the PDCCH to separately indicate different configurations for each slot in the group. Processor 622 may configure how many slots or which slots should be included in a group by higher layer signaling (e.g., RRC signaling).

In some implementations, processor 612 may be configured to multiplex the short PUCCH and the SRS in a TTI by FDM. The TTI may be an OFDM symbol. For example, processor 612 may multiplex the short PUCCH and the SRS within the same OFDM symbol and in different sub-carriers. Processor 622 may configure communication apparatus 610 to transmit its SRS in a first set of sub-carriers and transmit its short PUCCH in a second set of sub-carriers. The first set of sub-carriers may be different from the second set of sub-carriers. Processor 612 may schedule or multiplex the short PUCCH and the SRS in continuous sub-carriers or in non-continuous sub-carriers.

In some implementations, processor 622 may multiplex the short PUCCH and the SRS of different UEs in an OFDM symbol. For example, processor 622 may multiplex the short PUCCH and the SRS of a first UE with the short PUCCH and the SRS of a second UE within the same OFDM symbol and in different sub-carriers. Processor 622 may schedule or multiplex the short PUCCH and the SRS of different UEs in continuous sub-carriers or in non-continuous sub-carriers. Processor 622 may configure a first UE to transmit its SRS and short PUCCH in a first set of sub-carriers and configure a second UE to transmit its SRS and short PUCCH in a second set of sub-carriers. The first set of sub-carriers may be different from the second set of sub-carriers.

In some implementations, processor 622 may be configured to multiplex the short PUCCH and the SRS in an OFDM symbol by CDM. For example, processor 622 may multiplex the SRS of a first UE and the SRS of a second UE within the same OFDM symbol and in different sub-carriers. Processor 622 may multiplex or superpose the short PUCCH of the first UE with the SRS of the second UE in the same sub-carriers by CDM. Processor 622 may multiplex or schedule the short PUCCH and the SRS in an overlapping physical resource block or in non-overlapping physical resource blocks. Processor 622 may configure the first UE to transmit its short PUCCH in a first set of sub-carriers and configure the second UE to transmit its SRS in a second set of sub-carriers. The first set of sub-carriers may be identical to or overlapped with the second set of sub-carriers.

In some implementations, processor 612 may be configured to schedule the short PUCCH in non-continuous sub-carriers. For example, processor 612 may schedule the short PUCCH of a third UE in non-continuous sub-carriers and multiplex with the SRS of the first UE in an OFDM symbol by FDM. Processor 612 may interlace the short PUCCH of the third UE and the SRS of the first UE in continuous sub-carriers. Processor 622 may configure the third UE to transmit its short PUCCH in a first set of sub-carriers and configure the first UE to transmit its SRS in a second set of sub-carriers. The first set of sub-carriers may be interlaced with the second set of sub-carriers in continuous sub-carriers or in non-continuous sub-carriers. The first set of sub-carriers may be different from the second set of sub-carriers.

In some implementations, processor 612 may be configured to multiplex the short PUCCH and the SRS in an OFDM symbol by CDM. Processor 622 may multiplex or superpose the short PUCCH of the first UE with the SRS of the first UE in the same sub-carriers by CDM. Processor 622 may multiplex or schedule the short PUCCH and the SRS in an overlapping physical resource block or in non-overlapping physical resource blocks. Processor 622 may configure the first UE to transmit its short PUCCH in a first set of sub-carriers and transmit its SRS in a second set of sub-carriers. The first set of sub-carriers may be identical to or overlapped with the second set of sub-carriers.

### Illustrative Processes

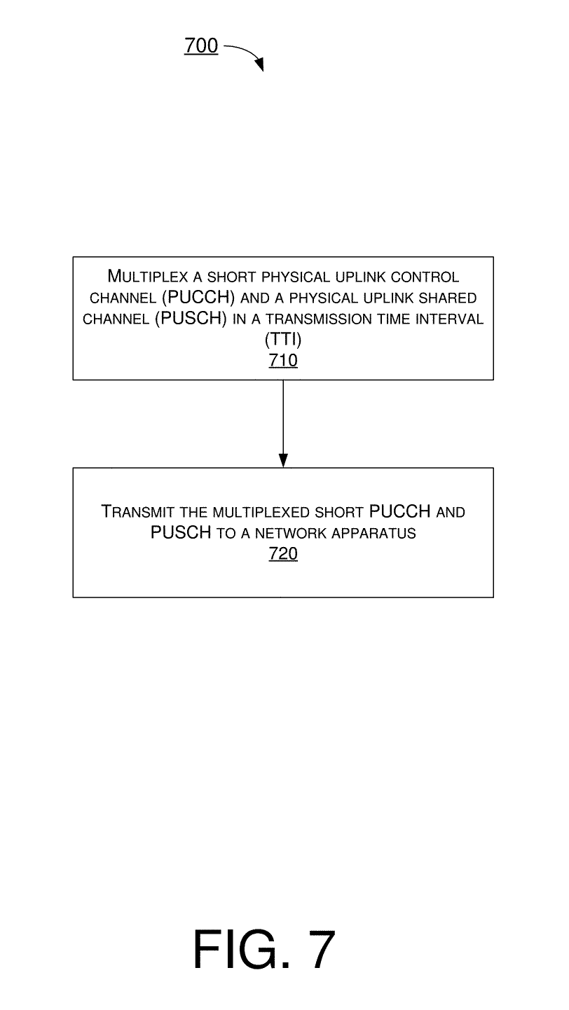

FIG. 7 illustrates an example process 700 in accordance with an implementation of the present disclosure. Process 700 may be an example implementation of scenarios 100, 120, 140, 160, 200, 220, 400, 420, 440 and 460, whether partially or completely, with respect to multiplexing physical uplink control channels in accordance with the present disclosure. Process 700 may represent an aspect of implementation of features of communication apparatus 610. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At 710, process 700 may involve communication apparatus 610 multiplexing a short physical uplink control channel (PUCCH) and a physical uplink shared channel (PUSCH) in a transmission time interval (TTI). Process 700 may proceed from 710 to 720.

At 720, process 700 may involve communication apparatus 610 transmitting the multiplexed short PUCCH and PUSCH to a network apparatus. The short PUCCH and the PUSCH may be multiplexed by time division multiplexing (TDM) or frequency division multiplexing (FDM).

In some implementations, the short PUCCH and the PUSCH may be multiplexed in the same time duration or in different time duration. In some implementations, the short PUCCH and the PUSCH may be multiplexed in an overlapping physical resource block or in non-overlapping physical resource blocks.

In some implementations, process 700 may involve communication apparatus 610 determining a first transmission power for the short PUCCH and a second transmission power for the PUSCH when the short PUCCH and the PUSCH are multiplexed in the same time duration.

In some implementations, process 700 may involve communication apparatus 610 performing rate-matching for the PUSCH to avoid an overlapping physical resource block when the short PUCCH and the PUSCH are multiplexed in the overlapping physical resource block.

In some implementations, process 700 may involve communication apparatus 610 puncturing the PUSCH in an overlapping physical resource block when the short PUCCH and the PUSCH are multiplexed in the overlapping physical resource block.

In some implementations, process 700 may involve communication apparatus 610 superposing the short PUCCH and the PUSCH when the short PUCCH and the PUSCH are multiplexed in an overlapping physical resource block.

In some implementations, process 700 may involve communication apparatus 610 receiving a control information from a network apparatus and multiplexing a short physical uplink control channel (PUCCH) and a physical uplink shared channel (PUSCH) in a transmission time interval (TTI) according to the control information. The control information may be configured by radio resource control (RRC) layer signaling or indicated by physical layer signaling or L1 signaling.

In some implementations, the control information may indicate at least one of a starting symbol index, an ending symbol index and number of symbols of the PUSCH. At least one of the starting symbol index, the ending symbol index and the number of symbols of the PUSCH may be indicated in separate fields or jointly encoded in one field. The control information may be applied to at least one of a TTI, multiple TTIs, and a group of TTIs.

In some implementations, the control information may be carried in a user equipment-specific (UE-specific) downlink control indicator (DCI) or in a group-common downlink control indicator (DCI).

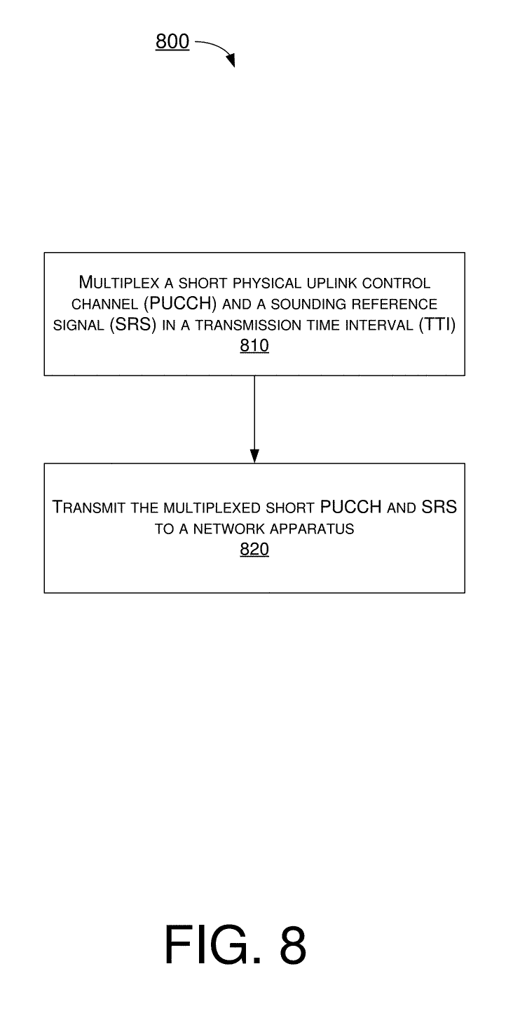

FIG. 8 illustrates an example process 800 in accordance with an implementation of the present disclosure. Process 800 may be an example implementation of scenarios 500, 520, 540 and 560, whether partially or completely, with respect to multiplexing physical uplink control channels in accordance with the present disclosure. Process 800 may represent an aspect of implementation of features of communication apparatus 610. Process 800 may include one or more operations, actions, or functions as illustrated by one or more of blocks 810 and 820. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order. Process 800 may be implemented by communication apparatus 610 or any suitable UE or machine type devices. Solely for illustrative purposes and without limitation, process 800 is described below in the context of communication apparatus 610. Process 800 may begin at block 810.

At 810, process 800 may involve communication apparatus 610 multiplexing a short physical uplink control channel (PUCCH) and a sounding reference signal (SRS) in a transmission time interval (TTI). Process 800 may proceed from 810 to 820.

At 820, process 800 may involve communication apparatus 610 transmitting the multiplexed short PUCCH and SRS to a network apparatus. The short PUCCH and the SRS may be multiplexed by time division multiplexing (TDM), frequency division multiplexing (FDM) or code division multiplexing (CDM).

In some implementations, the short PUCCH and the SRS may be multiplexed in an overlapping physical resource block or in non-overlapping physical resource blocks. In some implementations, the short PUCCH and the SRS may be multiplexed in continuous sub-carriers or in non-continuous sub-carriers.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
multiplexing, by a processor of an apparatus, a short physical uplink control channel (PUCCH) and a physical uplink shared channel (PUSCH) in a transmission time interval (TTI); and
transmitting, by the processor, the multiplexed short PUCCH and PUSCH to a network apparatus,
wherein the short PUCCH and the PUSCH are multiplexed by time division multiplexing (TDM) or frequency division multiplexing (FDM).

2. The method of claim 1, wherein the short PUCCH and the PUSCH are multiplexed in the same time duration or in different time duration.

3. The method of claim 1, wherein the short PUCCH and the PUSCH are multiplexed in an overlapping physical resource block or in non-overlapping physical resource blocks.

4. The method of claim 1, further comprising:
determining, by the processor, a first transmission power for the short PUCCH and a second transmission power for the PUSCH when the short PUCCH and the PUSCH are multiplexed in the same time duration.

5. The method of claim 1, further comprising:
performing, by the processor, rate-matching for the PUSCH to avoid an overlapping physical resource block when the short PUCCH and the PUSCH are multiplexed in the overlapping physical resource block.

6. The method of claim 1, further comprising:
puncturing, by the processor, the PUSCH in an overlapping physical resource block when the short PUCCH and the PUSCH are multiplexed in the overlapping physical resource block.

7. The method of claim 1, further comprising:
superposing, by the processor, the short PUCCH and the PUSCH when the short PUCCH and the PUSCH are multiplexed in an overlapping physical resource block.

8. The method of claim 1, wherein resource allocation for the short PUCCH and the PUSCH is configured by radio resource control (RRC) layer signaling or indicated by physical layer signaling or L1 signaling.

9. A method, comprising:
receiving, by a processor of an apparatus, control information from a network apparatus;
determining, by the processor, time duration of at least one of a physical uplink shared channel (PUSCH) and a physical downlink shared channel (PDSCH) in a transmission time interval (TTI) according to the control information; and
scheduling, by the processor, the TTI according to the determined time duration,
wherein the control information indicates the time duration of at least one of the PUSCH and the PDSCH,
wherein the control information is configured by radio resource control (RRC) layer signaling or indicated by physical layer signaling or L1 signaling.

10. The method of claim 9, wherein the control information indicates at least one of a starting symbol index, an ending symbol index and number of symbols of at least one of the PUSCH and the PDSCH.

11. The method of claim 10, wherein at least one of the starting symbol index, the ending symbol index and the number of symbols of at least one of the PUSCH and the PDSCH are indicated in separate fields or jointly encoded in one field.

12. The method of claim 9, wherein the control information is carried in a user equipment-specific (UE-specific) downlink control indicator (DCI) or in a group-common downlink control indicator (DCI).

13. The method of claim 9, wherein the control information is applied to at least one of a TTI, multiple TTIs, and a group of TTIs.

14. The method of claim 13, wherein the control information indicates the time duration of at least one of the PUSCH and the PDSCH by at least one of commonly indicating multiple TTIs, separately indicating each TTI and group-wise indicating the group of TTIs.

15. The method of claim 9, further comprising:
multiplexing, by the processor, at least one a short physical uplink control channel (PUCCH), a sounding reference signal (SRS) and a physical downlink control channel (PDCCH) with at least one of the PUSCH and the PDSCH in the TTI.

16. A method, comprising:
multiplexing, by a processor of an apparatus, a short physical uplink control channel (PUCCH) and a sounding reference signal (SRS) in a transmission time interval (TTI); and
transmitting, by the processor, the multiplexed short PUCCH and SRS to a network apparatus,
wherein the short PUCCH and the SRS are multiplexed by time division multiplexing (TDM), frequency division multiplexing (FDM) or code division multiplexing (CDM).

17. The method of claim 16, wherein the short PUCCH and the SRS are multiplexed in an overlapping physical resource block or in non-overlapping physical resource blocks.

18. The method of claim 16, wherein the short PUCCH and the SRS are multiplexed in continuous sub-carriers or in non-continuous sub-carriers.
